(19) United States
(12) Patent Application Publication
(10) Pub. No.: US 2026/0063824 A1
(43) Pub. Date: Mar. 5, 2026

(54) SYSTEMS AND METHODS FOR PERFORMING DIAGNOSTIC ANALYSIS OF FRACTURE NETWORKS

(71) Applicant: University of Kansas, Lawrence, KS (US)

(72) Inventors: Amirmasoud Kalantari Dahaghi, Lawrence, KS (US); Vuong Van Pham, Lawrence, KS (US)

(21) Appl. No.: 19/106,133

(22) PCT Filed: Aug. 24, 2023
(86) PCT No.: PCT/US2023/072841

§ 371 Date: Feb. 24, 2025

Related U.S. Application Data
(60) Provisional application No. 63/400,584, filed on Aug. 24, 2022.

(51) Int. Cl. G01V 20/00; E21B 49/00; G06N 3/045

(52) U.S. Cl. CPC G01V 20/00; E21B 49/00; G06N 3/045; E21B 2200/20; E21B 2200/22

(57) ABSTRACT

Accurately and precisely characterizing a fracture network in a material, such as rocks of a rock formation, in real-time is challenging. However, an accurate and precise characterization can be generated by receiving sensor data from sensors deployed within the material, on the material, or both. The sensor data is converted into processed data from which cluster data is derived. The cluster data includes information corresponding to a geometry and an internal structure of at least a portion of the fracture network. One or more models of the fracture network is generated based on the cluster data. The one or more models are evaluated based on simulations.

### CROSS REFERENCE TO RELATED APPLICATIONS

This application claims the benefit of U.S. Provisional Patent Application No. 63/400,584 entitled “Systems and Methods for Performing Diagnostic Analysis of Fracture Networks” and filed on Aug. 24, 2022, which is expressly incorporated herein by reference in its entirety.

### GOVERNMENT INTEREST

This invention was made with government support under DE-FE0031784 awarded by the Department of Energy. The government has certain rights in the invention.

### TECHNICAL FIELD

The present disclosure generally relates to real-time modeling of fracture networks in materials, such as rock formations.

### BACKGROUND

Understanding of a sub-surface fracture network in rock formations is critical for environmentally sound exploitation of sub-surface resources, such as extraction of sub-surface hydrocarbon deposits. Currently, at least four techniques are deployed to acquire information about these sub-surface fracture networks: analytical and mechanical methods, traditional sensors, fiber optics, and borehole imaging. Examples of analytical and mechanical methods include net pressure, plot analysis, and caliper logs. Tracers are examples of traditional sensors, while distributed acoustic sensing (DAS) and distributed temperature sensing (DTS) are examples of fiber optics. A drawback common to each of the foregoing techniques is that the data that they generate requires further interpretation to be useful in characterizing a fracture network in a material, such as in a rock formation. A further drawback common to these techniques is that, once the data is analyzed, the characterization of the fracture network corresponding to the data represents a state of the fracture network in the past, when the data was collected, rather than a present state of the fracture network. However, fracture networks are dynamic and may change significantly within short timeframes.

Inaccurate or imprecise modeling of the topology and geomechanical properties of a fracture network may be financially and environmentally costly. For example, in drilling for resources, such as hydrocarbon resources, hydrological resources, or combinations thereof, a drilling location is often based on models of the subsurface fracture network. Accordingly, if the models of the subsurface fracture network are inaccurate or imprecise, the drilling location may be incorrect. The financial and environmental costs of drilling in incorrect locations may be significant.

### SUMMARY

Disclosed are systems, methods, computer-readable storage media, and devices for performing diagnostic analysis of facture networks through application of a bipartite technique. In a first part of the bipartite technique, an unsupervised learning module receives sensor data from a plurality of sensors disposed randomly within a facture network of a material, such as within a rock formation. The unsupervised learning module identifies clusters of temporospatial points within the sensor data. In a second part of the bipartite technique, a simulation module predicts a response of the material based on application of an artificial intelligence algorithm to the one or more clusters of temporospatial points. The artificial intelligence algorithm may be trained to predict physics-based responses of materials having fracture network topologies corresponding to a plurality of templates stored in a memory of a computing system, each template of which corresponds to a different hypothetical or actual fracture network topology.

In an aspect, a system for real-time characterization of a fracture network in a material is provided. The system may include one or more memories storing a plurality of templates. Each template of the plurality of templates may correspond to a different hypothetical or actual fracture network topology. Further, the system may include one or more processors communicatively coupled to the one or more memories. The one or more processors may be configured to identify one or more clusters of temporospatial points within sensor data received from a plurality of sensors disposed within the material. Moreover, the one or more processors may be configured to predict a response of the material based on application of an artificial intelligence algorithm to the one or more clusters of temporospatial points. The artificial intelligence algorithm may be trained to predict physics-based responses of materials having fracture network topologies corresponding to the plurality of templates.

In an aspect, a method performed by one or more processors of a fracture network analysis device for real-time characterization of a fracture network in a material is provided. The method includes identifying one or more clusters of temporospatial points within sensor data received from a plurality of sensors disposed within the material having a fracture network. Additionally, the method includes predicting a response of the material based on applying an artificial intelligence algorithm to the one or more clusters of temporospatial points. The artificial intelligence algorithm may be trained to predict physics-based responses of materials having fracture network topologies corresponding to a plurality of templates stored in a memory of the fracture network analysis device. Further, each template of the plurality of templates may correspond to a different hypothetical or actual fracture network topology.

In an aspect, a non-transitory computer-readable storage medium storing instructions that, when executed by one or more processors, cause the one or more processors to perform operations for real-time characterization of a fracture network in a material is provided. The operations include identifying one or more clusters of temporospatial points within sensor data received from a plurality of sensors disposed within the material having a fracture network. Additionally, the operations include predicting a response of the material based on applying an artificial intelligence algorithm to the one or more clusters of temporospatial points. The artificial intelligence algorithm may be trained to predict physics-based responses of materials having fracture network topologies corresponding to a plurality of templates stored in the non-transitory computer-readable storage medium. Further, each template of the plurality of templates may correspond to a different hypothetical or actual fracture network topology.

### BRIEF DESCRIPTION OF THE DRAWINGS

For a more complete understanding of the present disclosure, reference is now made to the following descriptions taken in conjunction with the accompanying drawings, in which:

FIG. 1 is a block diagram illustrating an example of a system that supports performance of diagnostic analysis of fracture networks according to one or more aspects of the disclosure;

FIGS. 2A-2C are block diagrams illustrating example operations for performance of diagnostic analysis of fracture networks according to one or more aspects of the disclosure;

FIG. 3 is a flow diagram illustrating example operations for performance of diagnostic analysis of fracture networks according to one or more aspects of the disclosure; and.

FIGS. 4A and 4B are flow diagrams illustrating example operations for performing diagnostic analysis of fracture networks according to one or more aspects of the disclosure.

### DETAILED DESCRIPTION OF THE INVENTION

Disclosed are systems, methods, computer-readable storage media, and devices for performing diagnostic analysis of facture networks through application of machine learning based on application of a bipartite technique. In a first part of the bipartite technique, sensor data is received from a plurality of sensors disposed within a facture network of a material, such as within a rock formation. The sensor data may be evaluated to identify groups of sensors having corresponding sensor data representative of a fracture network within the material. For example, a clustering algorithm may be used to identify clusters of temporospatial points within the sensor data, in which each cluster represents a group of sensors that are disposed in close proximity (e.g., are located within a fracture network of the material). The clusters of sensor data may be provided as an input to a machine learning model configured to simulate a physics-based response of the material based on the fracture network topology or topologies corresponding to the clusters derived from the sensor data. It is noted that the simulation of the physics-based response may account for various types of properties, including topological and geomechanical properties of the material.

In an aspect, the machine learning model may be trained to simulate physics-based responses based on a plurality of templates representing hypothetical or actual fracture networks and that may be stored in a memory of a computing device. To facilitate the training, templates representing different fracture networks or combinations of fracture networks may be provided to the model and simulations performed. Predicted responses may be compared to real-world observed responses (e.g., empirical data such as may be stored in a memory of a computing device) to generate labeled training data. As an example, a template representing one or more fracture networks, the predicted response during the simulations of which are similar to (i.e., within a threshold tolerance) to real-world response(s) may be labeled as passing. Once the training has reached a threshold level of performance (e.g., accuracy, speed, etc.), the model may be used to simulate responses based on fracture networks identified based on the clustering of the sensor data, thereby enabling real-time analysis of fracture networks within materials, such as within rock formations. In an aspect, the clusters of sensor data may be compared to the plurality templates to identify one or more types of fracture networks within the material and the templates corresponding to the identified clusters may be provided to the model for simulation rather than the sensor data itself.

In an aspect, an unsupervised learning module may match one or more clusters of temporospatial points to template data, stored in a memory of a computing device. The template data may include one or more templates that correspond to actual or hypothesized topological models of fracture networks. In a second part of the bipartite technique, a simulation module predicts a response of a material containing one or more fracture networks, such as a rock formation, based on application of an artificial intelligence algorithm to the one or more clusters of temporospatial points. The artificial intelligence algorithm is trained to predict physics-based responses of materials having fracture network topologies corresponding to the plurality of templates. These properties may include topological and geomechanical properties of the one or more templates of the plurality of templates that have been matched to the clusters of temporospatial points. As used herein, geomechanical properties include geophysical properties.

For example, the simulation module may include one or more artificial neural networks (ANNs) that have been trained on template data corresponding to the plurality of templates. In particular, a large volume of template data (e.g., thousands, hundreds of thousands, or millions of instantiations of template data) corresponding to templates such as those representing different hypothesized topologies of hypothetical fracture networks on which physical simulations have been performed and are known to be accurate and precise, historical fracture networks about which topological and geomechanical data has been collected, or both may have been provided to the one or more ANNs associated with the simulation module. Additionally, the one or more ANNs may have been trained on geomechanical properties associated with the template data, such as simulated geomechanical properties of the one or more templates corresponding to the template data. Accordingly, by training the one or more ANNs in this manner, the one or more trained ANNs may be configured to accurately and precisely simulate geomechanical properties of the one of more fracture networks from which the sensor data was obtained. Thus, the one or more trained ANNs may be configured to generate, in real time and based on received sensor data, models that, with a high probability, such as with a probability that satisfies a threshold value (e.g., stored in a memory of a computing device), accurately and precisely model the actual topological and geomechanical properties of the one or more fracture networks from which the sensor data was obtained.

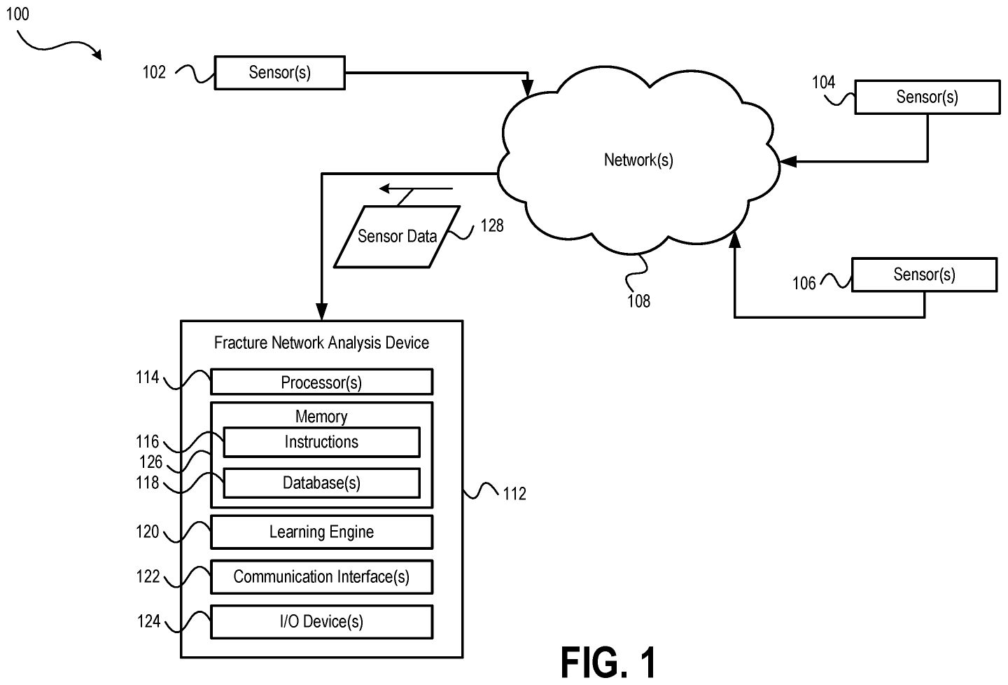

Referring to FIG. 1, a block diagram illustrating an example of a system that supports performance of diagnostic analysis of fracture networks according to one or more aspects of the disclosure is shown as fracture network analysis system 100. As shown in FIG. 1, fracture network analysis system 100 includes one or more sensors, shown as sensors 102-106, network 108, and fracture network analysis device 112.

Sensors 102-106 may be any sensor configured to generate and transmit sensor data 128 in accordance with the concepts described herein. Sensors 102-106 may be disposed within a material that may have one or more factures and in which the fractures may be on a surface of the material, embedded within the material, or both. The material may be a rock formation, such as a reservoir. As an example, one or more of sensors 102-106 may correspond to smart micro-chip proppants (SMPs), which are wirelessly powered and mesh-measured devices that are embedded with one or more sensor components and that are configured to withstand high reservoir temperatures and pressures, such as are typically found within rock formations. Sensor data 128 may include real-time geo-sensor data, such as temperature data, pressure data, imaging data, and the like. One or more of sensors 102-106 may be configured to transmit sensor data 128, through wireless or wired means, to fracture network analysis device 112 via network 108. For example, one or more sensors 102-106 may be stimulated by and receive power from an externally applied electromagnetic signal, and may, in response to receipt of the externally applied electromagnetic signal, enter into an active mode to collect and transmit data.

One or more of sensors 102-106 may be configured to temporally separate sensor data 128 and to generate a sensor data vector based on the temporally separated sensor data 128. Sensor data vectors received from one or more of sensors 102-106 may be concatenated into a sensor data tensor. For example, fracture network analysis device 112 may be configured to concatenate sensor data vectors received from one or more of sensors 102-106 via network 108 into a sensor data tensor. Additionally or alternatively, a computing device communicatively coupled to sensors 102-106 via network 108 may be configured to receive sensor data vectors from one or more of sensors 102-106 and concatenate the sensor data vectors into a sensor data tensor prior to transmitting the sensor data tensor to fracture analysis device 112. Additionally or alternatively, at least one of sensors 102-106 may be configured to collect or aggregate the sensor data from other ones of sensors 102-106, generate the sensor data tensor, and transmit the sensor data tensor to fracture network analysis device 112.

Fracture network analysis device 112 may include one or more processors 114 (collectively referred to as “processor 114”), one or more memories 126 (collectively referred to as “memory 126”), learning engine 120, one or more communication interfaces 122 (collectively referred to as “communication interface 122”), and one or more input/output (I/O) devices 124 (collectively referred to as “I/O device 124”). Memory 126 may be configured to store instructions 116 and one or more databases 118 (collectively referred to as “database 118”). Each processor 114 may be a microprocessor, a graphical processing unit (GPU), one or more field programmable gate arrays (FPGAs), a microcontroller, and/or an application specific integrated circuit (ASIC) or other logic circuitry configured to perform the operations described herein with reference to machine learning enable fracture analysis device 112.

Memory 126 may include a random access memory (RAM), which can be synchronous RAM (SRAM), dynamic RAM (DRAM), synchronous dynamic RAM (SDRAM), or the like. Memory 126 may also include read only memory (ROM), which can be programmable read only member (PROM), erasable programmable read only member (EPROM), electrically erasable programmable read only memory (EEPROM), optical storage, or the like. Additionally, memory 126 may include hard disk drives (HDDs), solid state disk drives (SSDs), and other memory devices configured to store data in a persistent or a non-persistent state. Memory 126 may be configured to store instructions 116 and database 118. Instructions 116 include or correspond to computer-readable code that, when executed by processor 114, causes processor 114 to perform the functionality described herein with respect to fracture network analysis device 112. Database 118 may be configured to store information. For example, database 118 may be configured to store any of sensor data, sensor vectors, sensor tensors, template data, and the like.

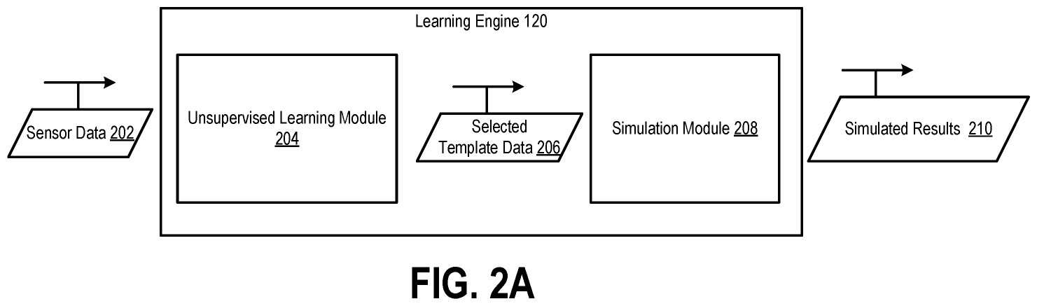

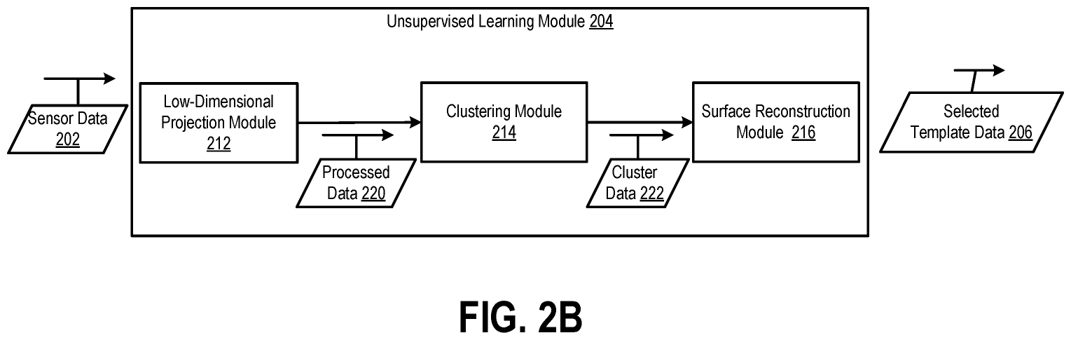

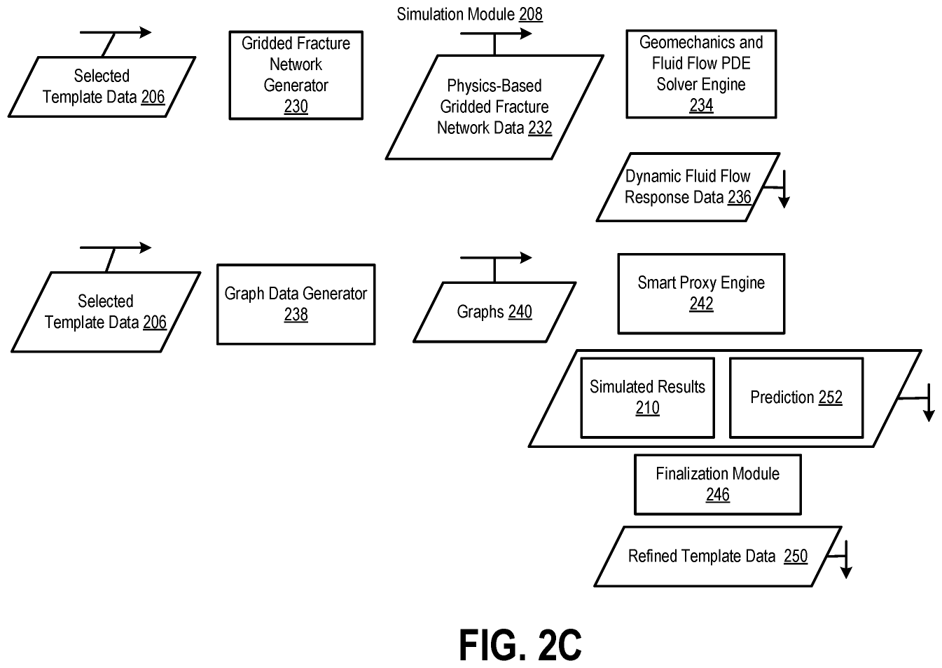

Processor 114 may be configured to execute learning engine 120. Learning engine 120 may correspond to instructions 116 to perform one or more functions described herein including with reference to FIGS. 2A-2C. In particular, learning engine 120 may correspond to components of an unsupervised learning module, a simulation module, or both. These components may include or correspond to one or more ANNs, to software that implements one or more algorithms, or a combination thereof. For example, the unsupervised learning module may be implemented in software that executes any one or more of a pairwise controlled manifold approximation (PACMAP) algorithm, a hierarchical density-based spatial clustering of applications with noise (HDBSCAN) algorithm, or a combination thereof. As another example, the simulation module may include or correspond to one or more ANNs. The one or more ANNs may include or correspond to any kind of ANN.

Communication interface 122 may be a network interface card (NIC), a transceiver, a transmitter, and/or a receiver. Communication interface 122 may be configured to communicate using a plurality of communication protocols, such as a Bluetooth™ protocol, a Zigbee™ protocol, and/or a cellular communication protocol, such as any of the 3G, 4G, and/or 5G communication protocols. Additionally, communication interface 122 may be any networking hardware capable of communicating using the 802.11 communication standard, the Ethernet communication standard, or other communication standards that may be developed.

I/O device 124 may include any device configured to receive input from a user (e.g., a user of fracture analysis device 112) and/or to provide output to the user. As examples, I/O device 124 may include a keyboard, a monitor or other display, a mouse, a printer, other types of I/O device(s), or a combination thereof. In an implementation, processor 114 may be configured to render data to or on the I/O device 124, such to a display device, or read information from the I/O device 124, such as inputs provided via a keyboard, a mouse, etc.

Referring to FIGS. 2A-2C, which are block diagrams illustrating example operations for performance of diagnostic analysis of fracture networks according to one or more aspects of the disclosure, a typical cycle of operation of system 100 is explained. As illustrated in FIG. 2A, learning engine 120 may include unsupervised learning module 204 and simulation module 208. Unsupervised learning module 204 may include or correspond to one or more hardware-implemented clustering algorithms, software-implemented clustering algorithms, or a combination thereof. For example, unsupervised learning module 204 may include or correspond to a PACMAP algorithm, a HDBSCAN algorithm, or a combination thereof. It is understood that unsupervised learning module 204 is not limited to the foregoing algorithms and may be implemented by other algorithms, such as by one or more ANNs.

Simulation module 208 may include or correspond to one or more hardware-implemented ANNs, one or more software-implemented ANNs, or a combination thereof. For example, the one or more ANNs may include or correspond to a convolutional ANN, a graph ANN, or a deep ANN. Moreover, simulation module 208 may be implemented by other algorithms that may not include or correspond to ANNs. Further, simulation module 208 may include physics-based simulation software configured to simulate the geomechanical properties of one or more mathematical models. For instance, simulation module 208 may include physics-based simulation software configured to simulate the geomechanical properties of a material or formation (e.g., a rock formation) that includes one or more fracture network corresponding to a template. Alternatively or additionally, the ANNs themselves may be configured to perform geomechanical simulations. For example, the ANNs themselves may be trained to generate physics-based simulations.

As depicted in FIG. 2A, unsupervised learning module 204 receives sensor data 202. In an aspect, sensor data 202 may be sensor data 128 of FIG. 1 and may be received from plurality of sensors 102-106 of FIG. 1, which may be disposed within the material (e.g., one or more fractures of a rock formation). Sensor data 202 may include one or more temporospatial points, each of which includes spatial data, temporal data, or both. The spatial data may include or correspond to a location of the sensor of the plurality of sensors 102-106 that collected the data. The temporal data may include a time at which the sensor of the plurality of sensors 102-106 collected or generated the data. While a temporospatial point may encode spatial data, temporal data, or both, the temporospatial point also may encode information about other aspects of the fracture network, such as a pressure, a temperature, or both at the space and time at which the sensor of the plurality of sensors 102-106 gathered the data.

Unsupervised learning module 204 may identify clusters of temporospatial points within sensor data 202. Unsupervised learning module 204 may identify the clusters of the temporospatial points based on template data, which may include or correspond to a plurality of templates. For example, the plurality of templates may be stored in a templates database included in database 118 stored in memory 126 of FIG. 1. Each template of the plurality of templates may correspond to different hypothetical or actual fracture network topologies. By identifying one or more templates of the plurality of templates that correspond to one or more clusters of temporospatial points, unsupervised learning module 204 may generate selected template data 206. Selected template data 206 may include or correspond to template data associated with the one or more templates, identified by unsupervised learning module 204, and that match the one or more clusters of temporospatial points. Accordingly, selected template data 206 may include or correspond to accurate and precise topological models of the one or more fracture networks from which sensor data 202 was obtained.

Simulation module 208 may receive selected template data 206. Based on selected template data 206, which may include or correspond to identified clusters of temporospatial points, simulation module 208 may predict a response of a material that includes one or more fracture networks based on application of an artificial intelligence algorithm to the one or more clusters of temporospatial points, to template data 206, or both. The artificial intelligence algorithm may be trained to predict physics-based responses of materials having fracture network topologies corresponding to the plurality of templates, such as to selected template data 206.

To illustrate, simulation module 208 may include one or more ANNs that have been trained on template data, such as stored in memory 126 of fracture network analysis device 112. For example, the one or more ANNs may be trained on many instantiations (e.g., thousands, hundreds of thousands, millions) of template data corresponding to the plurality of templates. In some implementations, the template data may correspond to a plurality of templates representing different hypothesized topologies of hypothetical fracture networks on which physical simulations have been performed and are known to be accurate and precise, historical fracture networks about which topological and geomechanical data has been collected, or both. Additionally or alternatively, the template data may correspond to a plurality of templates representing different hypothesized topologies of hypothetical fracture networks or topologies of actual fracture networks. The one or more ANNs may be trained to simulate the physics of the template data, such as the geomechanical behavior of the template data. In particular, the simulation module 208 may simulate a geomechanical behavior of the one or more templates of the plurality of templates. The results of these geomechanical simulations may be compared against data known to correspond to the actual physical behavior of the one or more templates. In some implementations, if the results of geomechanical simulations approximately match the data known to correspond to the actual physical behavior of the one or more templates, such as within an accepted uncertainty threshold value, the one or more ANNs may be considered to have been adequately trained. Conversely, if the results of the geomechanical simulations do not match the data known to correspond to the actual physical behavior of the one or more templates, the one or more ANNs may be considered to have been inadequately trained and further training may be performed.

Accordingly, after being trained and in response to receiving selected template data 206, simulation module 208 may be configured to generate simulated results 210 based on selected template data 206. Simulated results 210 may be compared against actual data obtained from the one or more fracture networks (e.g., such as may be included in sensor data 202), and learning engine 120 may be configured to identify, based on the comparison, those instantiations of selected template data 206 that, with a probability satisfying a threshold value, such as stored in memory 126, are most likely to accurately and precisely model the topological properties of the one or more fracture networks from which sensor data 202 was obtained, the geomechanical properties of the one or more fracture networks from which sensor data 202 was obtained, or both.

FIGS. 2B and 2C illustrate specific implementational details of unsupervised learning module 204 and simulation module 208, respectively, according to one or more aspects. Referring to FIG. 2B, unsupervised learning module 204 may include low dimensional projection module 212, clustering module 214, and surface reconstruction module 216. Low-dimensional projection module 212 may include or correspond to hardware-implemented algorithms, software-implemented algorithms, or both configured to convert higher dimensional data, such as data in three or more dimensions, into lower dimensional data, such as data in two or three dimensions. For example, low-dimensional projection module 212 may include or correspond to a manifold learning algorithm, such as PACMAP, configured to convert higher dimensional data into lower dimensional data, such as configured to convert three dimensional data into two dimensional data or to convert four dimensional data into three dimensional data. Clustering module 214 may include or correspond to hardware-implemented algorithms, software-implemented algorithms, or both configured to cluster data based, at least in part, on a temporospatial proximity among the data. In some implementations, clustering module 214 may include or correspond to a DBSCAN or HDBSCAN algorithm. Coupled DBSCAN-HDBSCAN is equipped to cope with degradation of the surface reconstruction performance in module 216. Surface reconstruction module 216 may include or correspond to hardware-implemented algorithms, software-implemented algorithms, or both configured to generate a plurality of hypothetical temporospatial realizations of the one or more fracture networks. In an aspect, a Poisson reconstruction algorithm may be utilized to generate the plurality of hypothetical temporospatial realizations.

During operation, low-dimensional projection module 212 may receive sensor data 202. Low-dimensional projection module 212 may be configured to reduce a dimensionality of sensor data 202 from a first dimensionality to a second dimensionality that is lower than the first dimensionality, thereby generating processed data 220. Accordingly, processed data 220 may be a lower dimensional version of sensor data 202.

For example, sensor data 202 may include a plurality of temporospatial points. Each temporospatial point of the plurality of temporospatial points may have a first value corresponding to a first space dimension (e.g., an x coordinate), a second value corresponding to a second space dimension (e.g., a y coordinate), a third value corresponding to a third space dimension (e.g., a z coordinate), and fourth value corresponding to a temporal dimension. The spatial dimensions may indicate a location of a sensor (e.g., sensor 102-106) within a fracture of the one or more fracture networks. The temporal dimension may indicate a time at which one or more sensors 102-106 captured sensor data 202. Low-dimensional projection module 212 may extract one or more dimensions from the temporospatial points to generate processed data 220 having fewer dimensions than the temporospatial points. In some implementations, processed data 220 may have two dimensions (e.g., an x coordinate, a y coordinate), while sensor data 202 has four dimensions. In other implementations, processed data 220 have three dimensions (e.g., three spatial dimensions, two spatial dimensions and a temporal dimension), while sensor data 202 may have four dimensions.

As another example, sensor data 202, from each sensor 102-106, may be separated temporally and may be represented by a temporal vector. The temporal vector data may be concatenated into a data tensor having four dimensions (e.g., three spatial dimensions and a temporal dimension). Low-dimensional projection module 212 may reduce a dimensionality of the data tensor into a lower dimensional tensor. Accordingly, processed data 220 may include or correspond to a lower dimensional tensor.

Reducing a dimensionality of sensor data 202 to lower dimensional processed data 220 enhances computational efficiency and reduces power consumed by fracture network analysis device 112 without sacrificing accuracy. To elaborate, computations performed on lower dimensional data are less computationally intensive and thus use less power than computations performed on higher dimensional data. However, pattern recognition and matching can be performed on lower dimensional data, such as processed data 220, with accuracy that is equal to or not significantly worse than pattern recognition and matching performed on higher dimensional data, such as sensor data 202. By conserving computational resources, fracture network analysis device 112 may also conserve power.

Clustering module 214 may be configured to receive processed data 220 from low-dimensional projection module 212. Additionally, clustering module 214 may be configured to identify one or more clusters of temporospatial points within processed data 220. The one or more groups or clusters of temporospatial points may be referred to as cluster data 222. For example, clustering module 214 may be configured to generate one or more groups or clusters of temporospatial points included within processed data 220 based on shared characteristics among these one or more groups or clusters of temporospatial points. These shared characteristics may include temporal proximity among the temporospatial points, spatial proximity among the temporospatial points, or a combination thereof. Additionally or alternatively, clustering module 214 may be configured to identify other types of patterns among one or more groups or clusters of the temporospatial points, such as topological features shared among the temporospatial points, similar pressure gradients corresponding to pressure data associated with the temporospatial points, similar temperature gradients corresponding to temperature data associated with the temporospatial points, or combinations thereof. Further, clustering module 214 may be configured to apply different types of clustering algorithms to generate cluster data 222. These different types of clustering algorithms may include a mixture clustering algorithm that applies a mixture clustering coefficient to perform the clustering of the temporospatial points, an ensemble clustering algorithm to perform ensemble clustering of the temporospatial points, a density-based clustering algorithm to perform density-based clustering of the temporospatial points, or combinations thereof.

In some implementations, cluster data 222 may be a tensor having the same dimensionality as processed data 220. Additionally, clustering module 214 may be configured to convert cluster data 222 from a first dimensionality to a second dimensionality having the same dimensionality as sensor data 202. For example, clustering module 214 may be configured to convert cluster data 222 from a low-dimensional tensor, having a same dimensionality as processed data 220, to a high-dimensional tensor, having a same dimensionality as sensor data 202.

Clustering module 214 may provide cluster data 222 to surface reconstruction module 216. Surface reconstruction module 216 may be configured to generate selected template data 206 based on cluster data 222. Selected template data 206 may include or correspond to one or more templates of a plurality of templates that model one or more topological properties, temporal properties, or both of one or more hypothesized fracture networks. For instance, the modeled topological properties may include a geometry, a complexity, or an aperture size of the one or more fracture networks. Additionally or alternatively, surface reconstruction module 216 may be configured to match cluster data 222 with template data corresponding to one or more templates of a plurality of templates that model one or more topological properties, temporal properties, or both of one or more hypothesized fracture networks. The matched template data may be referred to as selected template data 206.

Having generated selected template data 206, unsupervised learning module 204 may be configured to provide selected template data 206 to simulation module 208, as briefly explained above with reference to FIG. 2A. While selected template data 206 may correspond to hypothetical topological models of one or more fracture networks that are likely to model the topological properties of the one or more fracture networks from which sensor data 202 was obtained, selected template data 206 may nevertheless not correspond to or provide information and insights regarding the geomechanical properties of the one or more fracture networks from which sensor data 202 was obtained. In other words, selected template data 206 may correctly model topological or structural properties of the one or more fracture networks based on analysis, by unsupervised learning module 204, of sensor data 202; however, selected template data 206 may not account for or consider geomechanical properties of the one or more fracture networks from which sensor data 202 was obtained. However, simulation module 208 may be configured to perform geomechanical simulations on selected template data 206 to generate simulated results 210, which may be compared against actual data (e.g., sensor data 202) derived from the one or more fracture networks. Based on the comparison, instantiations of selected template data 206 that accurately and precisely model the topological and geomechanical properties of the one or more fracture networks from which sensor data 202 was obtained may be identified. In this manner, a response, such as a physics-based or geomechanical response, of the material in which the fracture network is located and from which sensor data 202 was obtained may be predicted.

Referring to FIG. 2C, operations of simulation module 208 are depicted. Simulation module 208 may include gridded fracture network generator 230, geomechanics fluid flow partial differential equations (PDE) solver engine 234, graph data generator 238, smart proxy engine 242, and finalization module 246. Gridded fracture network generator 230 may include or correspond to a hardware implemented algorithm, a software implemented algorithm, or a combination thereof configured to simulate the physics of one or more templates corresponding to selected template data 206. Geomechanics fluid flow PDE solver engine 234 may include or correspond to a hardware implemented algorithm, a software implemented algorithm, or a combination thereof configured to simulate a flow of fluid in or through the one or more templates corresponding to selected template data 206. Graph data generator 238 may include or correspond to a hardware implemented algorithm, a software implemented algorithm, or a combination thereof configured to generate graphs, based on selected template data 206, that correspond to a geomechanical behavior of the one or more templates associated with the selected template data 206. Smart proxy engine 242 may include or correspond to a hardware implemented algorithm, a software implemented algorithm, or a combination thereof configured to generate simulated results 210, prediction 252, or both based on inputs provided by one or more of gridded fracture network generator 230, geomechanics fluid flow partial differential equations (PDE) solver engine 234, graph data generator 238, or a combination thereof. Simulated results 210 may include or correspond to results of a physics-based simulation performed on selected template data 206, such as results of physics-based simulations performed on one or more templates associated with a plurality of templates corresponding to selected template data 206. Prediction 252 may include or correspond to one or more indications of which instantiations of selected template data 206 are most likely to accurately and precisely predict the topological properties of the one or more fracture networks, the geomechanical properties of the one or more fracture networks, or both. In implementations, gridded fracture network generator 230, geomechanics fluid flow partial differential equations (PDE) solver engine 234, graph data generator 238, smart proxy engine 242, and finalization module 246, or combinations thereof may include or correspond to one or more ANNs that have been trained on template data corresponding to a plurality of templates. In some implementations, the plurality of templates may model or correspond to hypothesized topological models of hypothetical fracture networks on which physical simulations have been performed and are known to be accurate and precise, historical fracture networks about which topological and geomechanical data has been collected, or both. In other implementations, the plurality of templates may include or correspond to one or more hypothesized models of a hypothetical fracture network, one or more hypothesized models of an actual fracture networks, or a combination thereof. For example, the plurality of templates may model one or more hypothetical fracture networks, one or more historical fracture networks for which topological data is available (e.g., stored in database 118), one or more historical fracture networks for which geomechanical data is available (e.g., stored in database 118), a combination thereof. Finalization module 246 may include or correspond to a hardware implemented algorithm, a software implemented algorithm, or a combination thereof configured to identify, based on simulated results 210, prediction 252, or both instantiations of selected template data 206 that are most likely to accurately and precisely model the topological properties of one or more fracture networks, the geomechanical properties of one or more fracture networks, or a combination thereof as refined template data 250. Thus, refined template data 250 may include or correspond to instantiations of selected template data 206 that are most likely to accurately and precisely model the topological properties of one or more fracture networks, the geomechanical properties of one or more fracture networks, or a combination thereof. In some implementations, one or more instantiations of selected template data 206 may be determined to most likely accurately and precisely model the topological properties of one or more fracture networks, the geomechanical properties of one or more fracture networks, or a combination thereof if a probability value assigned, by finalization module 246, to the one or more instantiations of selected template data 206, based on simulated results 210, prediction 252, or both, satisfies a threshold value, such as stored in memory 126. Additionally, in some implementations, finalization module 246 may signal, to a user, the one or more identified templates associated with refined template data 250 that most strongly correlate to topological and geomechanical properties of the one or more fracture networks.

During operation of simulation module 208, smart proxy engine 242 may receive input data from at least two sources. The first source of data may originate from geomechanics and fluid flow PDE solver engine 234 via gridded fracture network generator 230 and may include dynamic fluid flow response data 236 and physics-based gridded fracture network data 232. The second source of data may originate from graph data generator 238 and may include graphs 240. Described below is the origination and generation of data from each source.

With regard to the first source of data, gridded fracture network generator 230 may receive selected template data 206 from unsupervised learning module 204. Gridded fracture network generator 230 may generate physics-based gridded fracture network data 232 based on selected template data 206. Physics-based gridded fracture network data 232 may include or correspond to physical principles applied to one or more templates associated with selected template data 206. To elaborate, the one or more templates associated with selected template data 206 may mathematically model topological properties of the one or more fracture networks, but may not model geomechanical properties of the one or more templates. Gridded fracture network generator 230 may be configured to convert the one or more templates into geomechanical models that, in addition to modelling topological properties of the one or more fracture networks, also model geomechanical properties of the one or more facture networks. Accordingly, physics-based gridded fracture network data 232 may include or correspond to one or more templates that model the topological and geomechanical properties of the one or more fracture networks.

Geomechanics and fluid flow PDE solver engine 234 may be configured to receive physics-based gridded fracture network data 232 and may further be configured to simulate fluid flow through the one or more templates that correspond to or are included in physics-based gridded fracture network data 232. For example, geomechanics and fluid flow PDE solver engine 234 may be configured to apply geomechanical and fluid dynamics principles to simulate fluid flow (e.g., oil gas mixtures, water, oil gas and water mixtures, other fluids) through one or more templates that correspond to or are included in physics-based gridded fracture network data 232 to generate dynamic fluid flow response data 236. Accordingly, dynamic fluid flow response data 236 may include or correspond to the simulated flow of fluid through the one or more templates associated with physics-based gridded fracture network data 232. Geomechanics and fluid flow PDE solver engine 234 may be further configured to provide dynamic fluid flow response data 236 to smart proxy engine 242.

With regard to the second source of data, graph data generator 238 may receive an instantiation of selected template data 206 from unsupervised learning module 204 to generate one or more graphs (collectively “graphs 240”). Graph data generator 238 may generate graphs 240 corresponding to one or more templates of the plurality of templates associated with selected template data 206. The one or more graphs may correspond to an approximation of an expected geomechanical behavior of the one or more templates associated with the selected template data 206 and may be based on topological properties of the one or more templates associated with selected template data 206.

Accordingly, smart proxy engine 242 may be configured to receive dynamic fluid flow response data 236, physics-based gridded fracture network data 232, selected template data 206, or combinations thereof from geomechanics fluid flow PDE solver engine 234. Additionally, smart proxy engine 242 may be configured to receive graphs 240 from graph data generator 238. In some implementations, smart proxy engine 242 may include or correspond to one or more trained ANNs. Based on dynamic fluid flow response data 236, physics-based gridded fracture network data 232, selected template data 206, graphs 240, or combinations thereof, the one or more trained ANNs may be configured to generate simulated results 210, prediction 252, or a combination thereof.

To elaborate, the one or more ANNs associated with one or more components of simulation module 208 may be have been trained on instantiations of template data, such as may correspond to one or more templates of a plurality of templates known to accurately and precisely model the topological properties, the geomechanical properties, or both of one or more hypothetical and/or actual fracture networks. For example, thousands, hundreds of thousands, or millions of instantiations of template data may be provided to train the one or more ANNs. In some implementations, the instantiations of template data may correspond to one or more templates that are known to accurately and precisely model the topological properties, the geomechanical properties, or both of one or more actual fracture networks for which data is stored in database 118. In other implementations, the instantiations of template data may correspond to one or more templates that are known to accurately and precisely model the topological properties, the geomechanical properties, or both of one or more hypothetical fracture networks.

Alternatively or additionally, the one or more ANNs associated with one or more components of simulation module 208 may be have been trained on instantiations of template data corresponding to one or more templates of a plurality of templates known to inaccurately and/or imprecisely model the topological properties, the geomechanical properties, or both of one or more hypothetical and/or actual fracture networks. For example, thousands, hundreds of thousands, or millions of instantiations of template data may be provided to train the one or more ANNs. In some implementations, the instantiations of template data may correspond to one or more templates that are known to inaccurately and/or imprecisely model the topological properties, the geomechanical properties, or both of one or more actual fracture networks for which data is stored in database 118. In other implementations, the instantiations of template data may correspond to one or more templates that are known to inaccurately and/or imprecisely model the topological properties, the geomechanical properties, or both of one or more hypothetical fracture networks.

In some implementations, the one or more ANNs may be trained in accordance with a physics compliance indicator (PCI) for machine learning as described with reference to U.S. Provisional Patent Application No. 63/426,641 entitled “Physics Compliance Indicator (PCI) for Machine Learning,” filed on Nov. 18, 2022 and that is incorporated herein in its entirety by this reference. By training the one or more ANNs in accordance with the techniques described with reference to the foregoing provisional patent application, the one or more ANNs may be configured to identify patterns in dynamic fluid flow response data 236, physics-based gridded fracture network data 232, selected template data 206, graphs 240, or combinations thereof that comply with physical properties associated with fracture networks in addition to topological properties associated with fracture networks.

In response to receiving the foregoing training data, the one or more ANNs associated with one or more components of simulation module 208 may evolve to identify patterns in the input data, such as dynamic fluid flow response data 236, physics-based gridded fracture network data 232, selected template data 206, graphs 240, or combinations thereof that are indicative of the topological properties of one or more fracture networks, the geomechanical properties of one or more fracture networks, or both. Accordingly, in response to receipt, by the one or more trained ANNs associated with one or more components of simulation module 208, of input data, such as dynamic fluid flow response data 236, physics-based gridded fracture network data 232, selected template data 206, graphs 240, or combinations thereof, the one or more ANNs, such as may be associated with smart proxy engine 242 and/or other components of simulation module 208, may be configured to generate simulated results 210, prediction 252, or both.

Smart proxy engine 242 may be configured to provide simulated results 210, prediction 252, or both to finalization module 246, which may be configured to generate refined template data 250 based on simulated results 210, prediction 252, or both. For example, prediction 252 may indicate which instantiations of selected template data 206 are associated with simulated results 210 that most likely represent an accurate and a precise model of the one or more fracture networks from which sensor data 202 was obtained. Accordingly, based on prediction 252, simulated results 210, or both, finalization module 246 may be configured to identify one or more instances of selected template data 206 that most likely represent an accurate and a precise model of the one or more fracture networks as refined template data 250. For instance, in some implementations, finalization module 246 may be configured to compare simulated results 210 against available empirical data collected from the one or more fracture networks (e.g., sensor data 202). Instances of selected template data 206, simulated results 210 from which most closely correspond to the empirical data may be identified, by finalization module 246, as refined template data 250.

In some implementations, finalization module 246 may be configured to assign probability values to each instance of selected template data 206 for which simulated results 210, prediction 252, or both indicate that each such instance is likely to accurately and precisely model the one or more fracture networks. In response to the probability value exceeding a threshold probability value, such as may be stored in memory 126, finalization module 246 may be configured to identify such instances of refined template data 250 on a graphical user interface (GUI) presented to a user of fracture network analysis device 112 via I/O device 124.

In some implementations, a plurality of trained ANNs may be associated with simulation module 208. In these implementations, a first set of selected template data 206 having a first topology may be provided to first ANNs of the plurality of ANNs, and a second set of selected template data 206 having a second topology distinct from the first topology may be provided to second ANNs of the plurality of ANNs. The first ANNs and second ANNs may be configured, respectively to perform geomechanical simulations on each of the first set of selected template data 206 and the second set of selected template data 206, respectively, to generate, for each such set, simulated results 210 and predictions 252. In this manner, ANNs that have been optimized to predict physics-based responses of particular hypothesized topologies of the one or more fracture networks from which sensor data 202 was obtained may be deployed for enhanced operational efficiency.

Performing, by unsupervised learning module 204, an unsupervised learning process and performing, by simulation module 208, a process to convert sensor data 202 to simulated results which may then be compared against empirical data to identify one or more instances of refined template data 250 confers numerous advantages. One advantage includes enhancing a computational efficiency of fracture network analysis device 112. Prior art systems may directly analyze sensor data 202 in an attempt to generate models corresponding to one or more fracture networks. However, doing so is computationally inefficient, because many possible topologies of the one or more fracture networks, suggested by sensor data 202, may not physically correspond to the one or more fracture networks with a high degree of certainty. In contrast, by bifurcating the analysis of sensor data 202 into an unsupervised learning process, performed by unsupervised learning module 204, and a simulation process, performed by simulation module 208, topologies that are unlikely to correspond to the one or more fracture networks are eliminated from further analysis, thereby conserving computational resources for topologies that are determined to most likely to correspond to the one or more fracture networks.

To illustrate, by matching sensor data 202 with template data corresponding to one or more templates of a plurality of templates stored in memory 126 to generate selected template data 206, unsupervised learning module 204 is configured to identify template topologies that are most likely to correspond to the one or more fracture networks based on analyzed sensor data 202. Accordingly, simulation module 208 generates a geomechanical simulation of template topologies that are most likely to correspond to the one or more fracture networks from which sensor data 202 was obtained. In this manner, simulation module 208 does not expend computational resources to generate a geomechanical simulations of template topologies that are unlikely to correspond to the one or more fracture networks from which sensor data 202 was obtained, thereby conserving computational resources.

A further advantage includes reduced power consumption. By conserving computational resources as explained above, fracture network analysis device 112 may use less power than conventional devices that do not apply a bipartite methodology to model topological and geomechanical properties of fracture networks. Through less power utilization, fracture network analysis device 112 may be deployed through a cloud-based architecture. For example, while FIG. 1 depicts processor 114, memory 126, learning engine 120, communication interface 122, and I/O device 124 as being integrated, in some implementations, one or more of the forgoing may be dispersed geographically and may be configured to execute the functionality described herein through cloud-based operation. Hence, reduced power utilization may facilitate use of mobile or reduced footprint computation to effectuate the functionality described herein.

An additional advantage associated with the instant disclosure includes real-time processing of sensor data 128, 202. Since the one or more ANNs associated with one or more components of simulation module 208 may be trained on one or more instances of template data as explained above prior to receipt, by fracture network analysis device 112, of sensor data 128, 202, the one or more trained ANNs associated with smart proxy engine 242 may be configured to rapidly generate (e.g., in real-time) simulated results 210, prediction 252, or both based on selected template data 206 and derived from sensor data 128, 202. Finalization module 246 may rapidly generate refined template data 250 based on the available simulated results 210, prediction 252, or both to identify one or more instances of selected template data 206 as refined template data 250 that, with a probability satisfying a threshold probability value, accurately and precisely model the one or more fracture networks from which sensor data 202 was obtained. In contrast, prior art systems may not train ANNs prior to receipt, by such systems, of sensor data 128, 202. Accordingly, such ANNs may operate inefficiently with concomitantly delayed results. Thus, an advantage of the instant disclosure includes rapid, real-time processing of sensor data 128, 202 to generate simulated results 210, prediction 252, or both, which may, in turn, better inform drilling operations. To illustrate, based on simulated results 210, prediction 252, refined template data 250, or combinations thereof, provided to I/O device 124 of fracture network analysis device 112, better decisions may be made regarding a location, within a material of the fracture network from which sensor data 202 was obtained (e.g., a rock formation) to initiate drilling operations.

Another advantage of the instant disclosure includes generation of models that more accurately and precisely model the one or more fracture networks from which sensor data 202 is obtained than is possible using conventional techniques. In particular, the bipartite technique of the instant disclosure facilitates generation and identification of models (e.g., refined template data 250) that model not only topological properties of the one or more fracture networks but also the geomechanical properties of the one or more fracture networks. To illustrate, techniques implemented by unsupervised learning module convert sensor data 202 to selected template data 206 that corresponds to one or more templates of a plurality of templates that may model the topological properties of the one or more fracture networks from which sensor data 202 is obtained. Hence, unsupervised learning module 204 identifies, based on sensor data 202, potential topological models that may correspond to the one or more fracture networks from which sensor data 202 was obtained. Having generated topological models via processes implemented by unsupervised learning module 204, simulation model 208 is configured to generate simulated results 210 based on selected template data 206. In this manner, both topological properties and geomechanical properties of the one or more fracture networks may be modeled based on sensor data 128, 202.

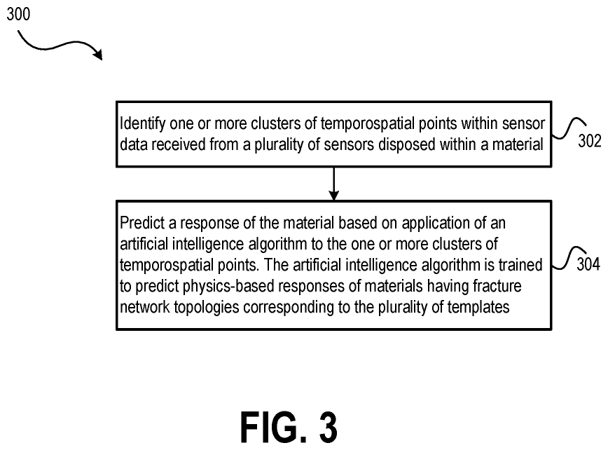

FIG. 3 is a flow diagram illustrating an example process 300 that supports diagnostic analysis of fracture networks. Operations of process 300 may be performed by fracture network analysis device 112. Example operations (also referred to as “blocks”) of process 300 may enable fracture network analysis device 112 to support an unsupervised learning process as described with reference to FIG. 2B and a simulation process as described with reference to FIG. 2C.

At block 302, a fracture network analysis device identifies one or more clusters of temporospatial points within sensor data received from a plurality of sensors disposed within a material. For example, fracture network analysis device 112 may be configured to identify one or more clusters of temporospatial points within sensor data 128, 202 received from plurality of sensors 102-106 disposed within a material that includes a fracture network, such as a rock formation.

At block 304, the fracture network analysis device predicts a response of the material based on application of an artificial intelligence algorithm to the one or more clusters of temporospatial points. The artificial intelligence algorithm is trained to predict physics-based responses of materials having fracture network topologies corresponding to a plurality of templates. For example, fracture network analysis device 112, executing, via processor 114, learning engine 120 may be configured to predict a response of the material, such as a fracture-laden rock formation, based on application of learning engine 120 to the one or more clusters of temporospatial points. Learning engine 120 may be trained to predict physics-based responses of materials having fracture network topologies corresponding to a plurality of templates, such as template data stored in memory 126. The plurality of templates may include or correspond to hypothesized templates that model hypothetical fracture networks, actual fracture networks, or a combination thereof.

In some implementations, a temporospatial point associated with the one or more clusters of temporospatial points encodes spatial data corresponding to a position, within the material, of a sensor (e.g., sensor 102-106), and encodes temporal data, indicating a time at which the sensor generated the sensor data (e.g., sensor data 128, 202). Further, in some implementations, a temporospatial point may encode other information, such as gathered by sensor 102-106. Such encoded information may include pressure data (e.g., corresponding to a pressure within the material), temperature data (e.g., corresponding to a temperature within the material), other geophysical data, or a combination thereof.

In some implementations, to identify the one or more clusters of temporospatial points, the one or more processors are configured to reduce a dimensionality of the sensor data. For example, processor 114, executing low-dimensional projection module 212 of unsupervised learning module 204, may receive higher-dimensional sensor data 202, such as in the form of an nth dimensional tensor, and may convert the higher dimensional data to a lower dimensional form, such as an mth dimensional tenor, where m is a lower dimension than n.

In some implementations, to identify the one or more clusters of temporospatial points, the one or more processors are configured to identify proximities of first one or more temporospatial points to second one or more temporospatial points. For example, processor 114, executing clustering module 214 of unsupervised learning module 204, may be configured to identify proximities of the first one or more temporospatial points to the second one or more temporospatial points. The proximities include temporal proximities, topological proximities, or both. For instance, first temporospatial points and second temporospatial points having temporal proximities may correspond to first temporospatial points having been collected by a first sensor, such as sensor 102, at a same or similar time as second temporospatial points having been collected by a second sensor, such as sensor 104. As another example, first temporospatial points and second temporospatial points having topological proximities may correspond to first temporospatial points having been collected by a first sensor, such as sensor 102, that may be proximate in space to second sensor, such as sensor 104 that may have collected second temporospatial points. While temporal proximities and topological proximities are provided as examples, it is understood that other relationships may exist among first temporospatial points and second temporospatial points. For instance, first temporospatial points and second temporospatial points may have a similar pressure gradient, temperature gradient, or both.

In some implementations, the one or more processors are further configured to: match the one or more clusters of temporospatial points to first one or more templates of the plurality of templates. For example, processor 114, executing surface reconstruction module 216 of unsupervised learning module 204, may be configured to match the one or more clusters of temporospatial points to first one or more templates of a plurality of templates stored in memory 126. To elaborate, processor 114 executing surface reconstruction module 216 may be configured to identify that one or more clusters of temporospatial points match a topology corresponding to first one or more templates of a plurality of templates.

Further, in some implementations, the one or more processors may be configured to receive sensor data, such as sensor data 202, from a plurality of sensors, such as sensors 102-106, disposed within the material. Additionally, the one or more processors may be configured to match at least first one or more clusters of temporospatial points to first one or more templates of the plurality of templates. For instance, processor 114, executing clustering module 214, may be configured to match at least first one or more clusters of temporospatial points, such as cluster data 222, to first one or more templates of the plurality of templates, such as may be stored in memory 126.

In some implementations, each first one or more templates corresponds to a hypothesized topology of the fracture network. For instance, first one or more templates may match topologies known to exist or generally be frequent in fracture networks, such as based of empirical data, historical data, or both. To illustrate, first one or more templates may include or correspond to selected template data 206.

In some implementations, to predict the response of the material based on applying the artificial intelligence algorithm, the one or more processors are configured to apply the artificial intelligence algorithm to the first one or more templates to simulate geomechanical properties of the first one or more templates. For example, processor 114 may be configured to apply simulation module 208 (e.g., one or more components of simulation module 208) to simulate geomechanical properties of the first one or more templates, such as selected template data 206. To illustrate, one or more trained ANNs, corresponding to one or more components of simulation module 208, may be configured to generate a geomechanical simulation of the first one or more templates. The simulated geomechanical properties of the first one or more templates may include a simulated flow of a hypothetical fluid through the first one or more templates. The hypothetical fluid may include or correspond to hydrocarbons, water-hydrocarbon mixtures, water, or any combination thereof.

In some implementations, to predict the response of the material based on applying the artificial intelligence algorithm, the one or more processors are configured to compare simulated data derived from the simulated geomechanical properties of each of the first one or more templates to empirical data obtained from the fracture network. The empirical data includes the sensor data. For example, processor 114, executing simulation module 208, may be configured to compare simulated data derived from the simulated geomechanical properties of each of the first one or more templates to empirical data, historical data, or a combination thereof obtained from the fracture network itself. The empirical data, historical data, or both may include or correspond to sensor data 202. For example, empirical data, historical data, or both that corresponds to the fracture network may be stored in memory 126, and processor 114, executing simulation module 208, may access the empirical data, historical data, or both to effectuate the comparison.

In some implementations, to predict the response of the material, the one or more processors may be configured to perform a geomechanical simulation on at least a set of templates of the first one or more templates. For instance, processor 114, executing simulation module 208, may be configured to perform a geomechanical simulation on at least a set of templates of the first one or more templates. The set of templates may include one or more of the first one or more templates. As an example, to perform the geomechanical simulation, processor 114 may be configured to provide one or more trained ANNs with the at least the set of templates of the first one or more templates.

In some implementations, to predict the response of the material, the one or more processors may be configured to compare simulation data generated from performing the geomechanical simulation to data derived from the fracture network. For instance, processor 114 may compare simulation data generated by simulation module 208 to data derived from or obtained from the fracture network from which sensor data 202 was obtained. The data derived from the fracture network includes empirical data, collected by the plurality of sensors, such as sensors 102-106, the empirical data included in the sensor data, such as sensor data 202.

In some implementations, to predict the response of the material, the one or more processors may be configured to identify second templates, within the set of templates, for which the simulation data matches the empirical data within a threshold uncertainty value stored in a memory of the fracture network analysis device. For instance, processor 114 may be configured to identify second templates, within the set of templates associated with selected template data 206, for which the simulation data matches the empirical data within a threshold uncertainty value stored in memory 126.

In some implementations, to predict the response of the material based on applying the artificial intelligence algorithm, the one or more processors are configured to identify, based on comparison of the simulation data to the empirical data, second one or more templates of the first one or more templates associated with the simulation data that match the empirical data within a threshold level of uncertainty. For example, processor 114, executing simulation module 208, may be configured to identify based on comparison of the simulation data to the empirical data, the historical data, or both, second one or more templates of the first one or more templates associated with the simulation data that match the empirical data, the historical data, or both within a threshold level of uncertainty, such as a threshold value stored in memory 126. For example, the second one or more templates of the first one or more templates may include or correspond to refined template data 250.

In some implementations, to identify the second one or more templates, the one or more processors are configured to generate a graphical user interface (GUI) that indicates a probability distribution associated with each of the second one or more templates. The probability distribution indicates a confidence in an accuracy and a precision of each of the second one or more templates as a model of the fracture network. For example, processor 114 may be configured to generate a GUI that indicates a probability associated with each of the second one or more templates and in which the probability indicates a likelihood that each of the second one or more templates accurately characterizes the topological properties of the fracture network from which sensor data 202 was obtained, the geomechanical properties of the fracture network from which sensor data 202 was obtained, or a combination thereof.

In some implementations, to predict the response of the material, the one or more processors, such as processor 114, may be configured to indicate, on a GUI (e.g., I/O device 124), probability values associated with each of the second templates, such as probability values associated with each of refined template data 250. The probability values may correspond to an extent to which each of the second templates accurately and precisely model topological characteristics of the fracture network from which sensor data 202 was obtained, geomechanical characteristics of the fracture network from which sensor data 202 was obtained, or both. In some implementations, the one or more processors, such as processor 114, may be configured to determine, based on simulation data (e.g., simulated results 210), probability values for each of or associated with each of the second templates (e.g., refined template data 250).

In some implementations, the artificial intelligence algorithm includes one or more ANNs. The one or more ANNs may include or correspond to one or more components of simulation module 208. For instance, the one or more ANNs may include or correspond to any one or more of gridded fracture network generator 230, geomechanics fluid flow partial differential equations (PDE) solver engine 234, graph data generator 238, smart proxy engine 242, finalization module 246, or combinations thereof.

In some implementations, a first ANN of the one or more ANNs is configured to receive a first set of the first one or more templates to simulate first geomechanical properties of the first set of the first one or more templates. For example, processor 114 executing simulation module 208 may be provided with a first set of first one or more templates, such as a first set of selected template data 206, to a first ANN that has been trained on and optimized to assess templates having a first topology. Additionally, in some implementations, a second ANN of the one or more ANNs is configured to receive a second set of the first one or more templates to simulate second geomechanical properties of the second set of the first one or more templates. For example, processor 114 executing simulation module 208 may be provided with a second set of second one or more templates, such as a second set of selected template data 206, to a second ANN that has been trained on and optimized to assess templates having a second topology. Moreover, in some implementations, first templates of the first set are topologically distinct from the second templates of the second set. For example, the first set of selected template data 206 may be topologically distinct from the second set of selected template data 206. By training ANNs on templates having particular topologies and then providing selected template data having similar topologies to each ANN, greater efficiencies may be had than providing selected template data 206 to a single ANN.

In some implementations, to predict the response of the material based on applying the artificial intelligence algorithm, the one or more processors are configured to train the one or more artificial intelligence algorithms. For instance, processor 114 may be configured to train one or more artificial intelligence algorithms, such as one or more components of simulation module 208.

In some implementations, the artificial intelligence algorithm includes one or more artificial neural networks (ANNs). For instance, one or more components of simulation module 208 may include or correspond to an ANN. Additionally or alternatively, one or more components of unsupervised learning module 204 may include or correspond to an ANN.

In some implementations, to train the one or more ANNs, the one or more processors are configured to provide the one or more ANNs with first one or more templates of the plurality of templates. For example, processor 114 may be configured to provide one or more ANNs associated with one or more components of simulation module 208 with first one or more templates, such as selected template data 206. In some implementations, the first one or more templates correspond to actual fracture network topologies, geomechanical behaviors of which are known based on empirical geomechanical data stored in the one or more memories. For instance, first one or more templates may correspond to template data associated with a plurality of templates and stored in memory 126. The template data may include or correspond to actual fracture network topologies, geomechanical behaviors of which are known based on empirical geomechanical data stored in the one or more memories, such as memory 126.

In some implementations, the first one or more templates correspond to hypothesized fracture network topologies, hypothesized geomechanical behaviors of which are known based on confirmed simulated geomechanical data stored in the one or more memories. For instance, first one or more templates of a plurality of templates stored in memory 126 may correspond to modeled or hypothesized fracture network topologies. These modeled or hypothesized network topologies may have been simulated, and the configured simulated geomechanical data obtained from performing simulations thereon may be stored in memory 126.

In some implementations, the one or more processors may be configured to generate simulated data through simulation, at the one or more ANNs, of geomechanical properties of the first one or more templates. For example, processor 114, executing simulation module 208, one or more components of which may include one or more ANNs, may be configured to simulate geomechanical properties of the first one or more templates.

In some implementations, the one or more processors may be configured to compare the simulated data to the empirical geomechanical data, to the confirmed simulated geomechanical data, or both. For instance, processor 114, executing simulation module 208 that may include one or more ANNs, may be configured to compare the simulated data to empirical geomechanical data (e.g., stored in memory 126), to the confirmed stimulated geomechanical data (e.g., stored in memory 126), or both.

In some implementations, in response to identification of a first match, within a threshold uncertainty value, between the simulated data and the empirical data or a second match, within the threshold uncertainty value, between the simulated data and the confirmed simulated geomechanical data, the one or more processors may be configured to cease performance of training. For example, processor 114, executing simulation module 208, may be configured to cease providing training data (e.g., the one or more templates), to the one or more ANNs associated with simulation module 208 in response to identification of a first match, within a threshold uncertainty value, such as may be stored in memory 126, between the simulated data and the empirical data or a second match, within the threshold uncertainty value, between the simulated data and the confirmed simulated geomechanical data.

In other implementations, in response to identification of a first deviation, within a threshold uncertainty value, between the simulated data and the empirical data or a second deviation, within the threshold uncertainty value, between the simulated data and the confirmed simulated geomechanical data, the one or more processors, such as processor 114, may be configured to continue providing training data (e.g., templates) to simulation module 208.

In some implementations, the one or more processors are further configured to indicate one or more drilling locations based on the predicted response. For example, processor 114 may be configured to indicate, via I/O device 124, a location for initiating drilling in a material in which the fracture network is located. To illustrate, processor 114 may be configured to indicate, via the I/O device 124, that drilling should be initiated at a particular location of a rock formation in which the fracture network is located.

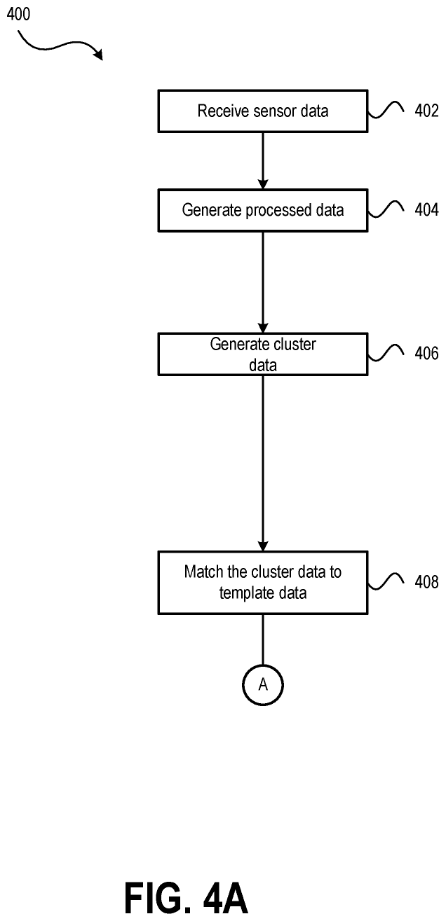

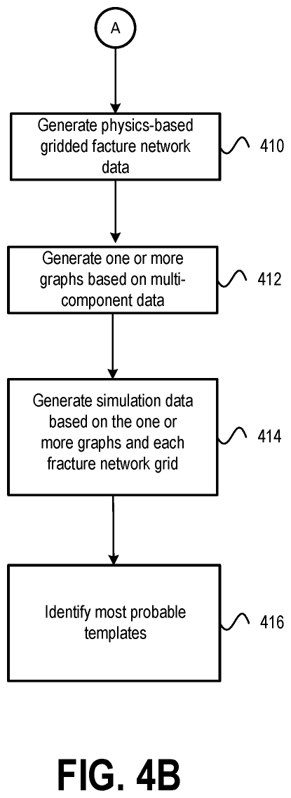

FIGS. 4A and 4B are flow diagrams illustrating an example process 400 that supports diagnostic analysis of fracture networks according to one or more aspects of the disclosure. Operations of process 400 may be performed by fracture network analysis device 112. Example operations (also referred to as “blocks”) of process 400 may enable fracture network analysis device 112 to support an unsupervised learning process as described with reference to FIG. 2B and a supervised learning process as described with reference to FIG. 2C. In particular, FIG. 4A may include operations that correspond to the unsupervised learning process, and FIG. 4B may include operations that correspond to the supervised learning process.

At block 402, a fracture network analysis device, such as fracture network analysis device 112, receives sensor data, such as sensor data 128, 202 from one or more sensors 102-106 disposed within one or more factures of a fracture network. In particular, learning engine 120, that includes unsupervised learning module 204 and supervised learning module 208, may be configured to receive the sensor data.

At block 404, the fracture network analysis device, such as fracture network analysis device 112, may generate processed data, such as processed data 220. For example, low-dimensional projection module 212 of unsupervised learning module 204, may be configured to reduce a dimensionality of sensor data 202 to processed data 220 having a lower dimensionality than sensor data 202. To illustrate, low-dimensional projection module 212 may receive sensor data 202 having a first dimensionality, such as in the form of a four dimensional tensor, and may reduce the dimensionality of sensor data 202 to processed data 220, such as in the form of a three dimensional tensor.

At block 406, the fracture network analysis device, such as fracture network analysis device 112, may generate cluster data, such as cluster data 222. For example, clustering module 214, such as unsupervised learning module 204, may convert processed data 220 to cluster data 222. In particular, clustering module 214 may cluster or group one or more temporospatial points corresponding to processed data 220 into clusters or groups of temporospatial points corresponding to cluster data 222. For instance, clustering module 214 may identify that a first set of temporospatial points associated with processed data 220 are topologically similar and may group these temporospatial points to form a first group of cluster data 222. As another example, clustering module 214 may identify that a second set of temporospatial points associated with processed data 220 are topologically similar and may group these temporospatial points to form a second group of cluster data 222.

At block 408, the fracture network analysis device, such as fracture network analysis device 112, may match cluster data 222 to template data to generate selected template data 206. In particular, template data may include or correspond to one or more templates of a plurality of templates, each of which may correspond to a hypothesized topological configuration of the one or more fracture networks. Fracture network analysis device 112 may identify that one or groups of cluster data 222 match or correspond to one or more templates of the plurality of templates to generate selected template data 206.

At block 410, the fracture network analysis device, such as fracture network analysis device 112, may generate physics-based gridded fracture network data, such as gridded fracture network data 232. For example, gridded fracture network generator 230 of simulation module 208 may receive selected template data 206 from unsupervised learning module 204. Selected template data 206 may include or correspond to one or more templates of a plurality of templates determined to match a topology of one or more fracture networks with a probability satisfying a threshold value (e.g., stored in memory 126). Gridded fracture network generator 230 may modify selected template data 206 to generate physics-based gridded fracture network data 232 so that the one or more templates corresponding to selected template data 206 simulate the physics of a fracture network corresponding to the one or more templates given topological constraints associated with the one or more templates. In some implementations, a fluid flow through the one or more modified templates corresponding to physics-based gridded fracture network data 232 may be simulated, such as via geomechanics fluid flow PDE solver engine 234. In this manner, dynamic fluid flow response data 236 associated with each template modified by gridded fracture network generator 230 may be available.

At block 412, the fracture network analysis device, such as fracture network analysis device 112, may generate one or more graphs, such as graphs 240, based on multi-component data. For example, graph data generator 238 of supervised learning module 208 may generate graphs 240 based on selected template data 206. Additionally or alternatively, graph data generator 238 may receive other data inputs from which to generate graphs 240. For example, graph data generator 238 may receive dynamic fluid flow response data 236 from geomechanics and fluid flow PDE solver engine 234 and may generate graphs 240 based on dynamic fluid flow response data 236 in addition to other input data, such as selected template data 206.

At block 414, fracture network analysis device, such as fracture network analysis device 112, may generate simulation data based on the one or more graphs, such as graphs 240 and each fracture network grid, such as corresponding to physics-based gridded fracture network data 232. For example, in some implementations, one or more components of simulation module 208 may generate simulations (e.g., physics-based simulations) based on graphs 240, based on physics-based gridded fracture network data 232, or based on a combination thereof. The simulations may result in simulation data that simulates geomechanical properties of the one or more fracture networks.

At block 416, fracture network analysis device, such as fracture network analysis device 112, may identify templates that have the highest likelihood of accurately and precisely modeling the one or more fracture networks. For example, finalization module 246 may identify one or more templates associated with refined template data 250 that satisfy a threshold probability value stored in memory 126 indicating a high probability of accurately and precisely modeling properties of the one or more fracture networks.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

One or more components, functional blocks, and modules described herein with respect to FIGS. 1-4B may include processors, electronics devices, hardware devices, electronics components, logical circuits, memories, software codes, firmware codes, among other examples, or any combination thereof. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules, and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. In some implementations, a processor may also be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media can include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, hard disk, solid state disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed aspect, the term “substantially” may be substituted with “within [a percentage] of” what is specified, where the percentage includes 0.1, 1, 5, and 10 percent; and the term “approximately” may be substituted with “within 10 percent of” what is specified. The phrase “and/or” means and or.

Although the aspects of the present disclosure and their advantages have been described in detail, it should be understood that various changes, substitutions and alterations can be made herein without departing from the spirit of the disclosure as defined by the appended claims. Moreover, the scope of the present application is not intended to be limited to the particular implementations of the process, machine, manufacture, composition of matter, means, methods and processes described in the specification. As one of ordinary skill in the art will readily appreciate from the present disclosure, processes, machines, manufacture, compositions of matter, means, methods, or operations, presently existing or later to be developed that perform substantially the same function or achieve substantially the same result as the corresponding aspects described herein may be utilized according to the present disclosure. Accordingly, the appended claims are intended to include within their scope such processes, machines, manufacture, compositions of matter, means, methods, or operations.

What is claimed is:

1. A system for real-time characterization of a fracture network in a material, the system comprising:
one or more memories storing a plurality of templates, wherein each template of the plurality of templates corresponds to a different hypothetical or actual fracture network topology; and
one or more processors communicatively coupled to the one or more memories, the one or more processors configured to:
identify one or more clusters of temporospatial points within sensor data received from a plurality of sensors disposed within the material; and
predict a response of the material based on application of an artificial intelligence algorithm to the one or more clusters of temporospatial points, wherein the artificial intelligence algorithm is trained to predict physics-based responses of materials having fracture network topologies corresponding to the plurality of templates.

2. The system of claim 1, wherein a temporospatial point associated with the one or more clusters of temporospatial points encodes spatial data corresponding to a position, within the material, of a sensor, and encodes temporal data, indicating a time at which the sensor generated the sensor data.

3. The system of claim 1, wherein, to identify the one or more clusters of temporospatial points, the one or more processors are configured to reduce a dimensionality of the sensor data.

4. The system of claim 1, wherein, to identify the one or more clusters of temporospatial points, the one or more processors are configured to identify proximities of first one or more temporospatial points to second one or more temporospatial points, wherein the proximities include temporal proximities, topological proximities, or both.

5. The system of claim 1, wherein the one or more processors are further configured to:
match the one or more clusters of temporospatial points to first one or more templates of the plurality of templates, wherein each first one or more templates corresponds to a hypothesized topology of the fracture network.

6. The system of claim 5, wherein, to predict the response of the material based on applying the artificial intelligence algorithm, the one or more processors are configured to:
apply the artificial intelligence algorithm to the first one or more templates to simulate geomechanical properties of the first one or more templates;
compare simulated data derived from the simulated geomechanical properties of each of the first one or more templates to empirical data obtained from the fracture network, wherein the empirical data includes the sensor data; and
identify, based on comparison of the simulation data to the empirical data, second one or more templates of the first one or more templates associated with the simulation data that match the empirical data within a threshold level of uncertainty.

7. The system of claim 6, wherein, to identify the second one or more templates, the one or more processors are configured to:
generate a graphical user interface (GUI) that indicates a probability distribution associated with each of the second one or more templates, wherein the probability distribution indicates a confidence in an accuracy and a precision of each of the second one or more templates as a model of the fracture network.

8. The system of claim 6, wherein the artificial intelligence algorithm includes one or more artificial neural networks (ANNs).

9. The system of claim 6, wherein:
a first ANN of the one or more ANNs is configured to receive a first set of the first one or more templates to simulate first geomechanical properties of the first set of the first one or more templates,
a second ANN of the one or more ANNs is configured to receive a second set of the first one or more templates to simulate second geomechanical properties of the second set of the first one or more templates, and
first templates of the first set are topologically distinct from the second templates of the second set.

10. The system of claim 1, wherein, to predict the response of the material based on applying the artificial intelligence algorithm, the one or more processors are configured to train the one or more artificial intelligence algorithms.

11. The system of claim 10, wherein the artificial intelligence algorithm includes one or more artificial neural networks (ANNs), and wherein, to train the one or more ANNs, the one or more processors are configured to:
provide the one or more ANNs with first one or more templates of the plurality of templates, wherein:
the first one or more templates correspond to actual fracture network topologies, geomechanical behaviors of which are known based on empirical geomechanical data stored in the one or more memories,
the first one or more templates correspond to hypothesized fracture network topologies, hypothesized geomechanical behaviors of which are known based on confirmed simulated geomechanical data stored in the one or more memories, or
a combination thereof;
generate simulated data through simulation, at the one or more ANNs, of geomechanical properties of the first one or more templates;
compare the simulated data to the empirical geomechanical data, to the confirmed simulated geomechanical data, or both; and
in response to identification of a first match, within a threshold uncertainty value, between the simulated data and the empirical data or a second match, within the threshold uncertainty value, between the simulated data and the confirmed simulated geomechanical data, cease performance of training.

12. The system of claim 1, wherein the one or more processors are further configured to:
indicate one or more drilling locations based on the predicted response.

13. A method performed by one or more processors of a fracture network analysis device for real-time characterization of a fracture network in a material, the method comprising:
identifying one or more clusters of temporospatial points within sensor data received from a plurality of sensors disposed within the material having a fracture network; and
predicting a response of the material based on applying an artificial intelligence algorithm to the one or more clusters of temporospatial points, wherein the artificial intelligence algorithm is trained to predict physics-based responses of materials having fracture network topologies corresponding to a plurality of templates stored in a memory of the fracture network analysis device, and wherein each template of the plurality of templates corresponds to a different hypothetical or actual fracture network topology.

14. The method of claim 13, further comprising:
receiving the sensor data from a plurality of sensors disposed within the material, wherein identifying the one or more clusters of temporospatial points within sensor data includes:
matching at least first one or more clusters of temporospatial points to first one more templates of the plurality of templates, wherein each first one or more templates corresponds to a hypothesized topology of the fracture network.

15. The method of claim 14, wherein predicting the response of the material includes:
performing a geomechanical simulation on at least a set of templates of the first one or more templates;
comparing simulation data generated from performing the geomechanical simulation to data derived from the fracture network, wherein the data derived from the fracture network includes empirical data collected by the plurality of sensors, the empirical data included in the sensor data;
identifying second templates, within the set of templates, for which the simulation data matches the empirical data within a threshold uncertainty value stored in a memory of the fracture network analysis device; and
indicating, on a graphical user interface (GUI), probability values associated with each of the second templates, wherein the probability values correspond to an extent to which each of the second templates accurately and precisely model topological characteristics of the fracture network, geomechanical characteristics of the fracture network, or both.

16. The method of claim 15, further comprising:
determining, based on the simulation data, the probability values for each of the second templates.

17. A non-transitory computer-readable storage medium storing instructions that, when executed by one or more processors, cause the one or more processors to perform operations for real-time characterization of a fracture network in a material, the operations including:
identifying one or more clusters of temporospatial points within sensor data received from a plurality of sensors disposed within the material having a fracture network; and
predicting a response of the material based on applying an artificial intelligence algorithm to the one or more clusters of temporospatial points, wherein the artificial intelligence algorithm is trained to predict physics-based responses of materials having fracture network topologies corresponding to a plurality of templates stored in the non-transitory computer-readable storage medium, wherein each template of the plurality of templates corresponds to a different hypothetical or actual fracture network topology.

18. The non-transitory computer-readable storage medium of claim 17, wherein the operations further include:
identifying, based on predicting the response of the material, one or more locations for initiating drilling operations in the material, wherein the material corresponds to a rock formation, and the fracture network corresponds to a reservoir within the rock formation.

19. The non-transitory computer-readable storage medium of claim 17, wherein the artificial intelligence algorithm includes one or more artificial neural networks (ANNs), and wherein predicting the response of the material includes:
training the one or more ANNS, wherein training the one or more ANNs includes providing templates of the plurality of templates to the one or more ANNs.

20. The non-transitory computer-readable storage medium of claim 17, wherein the physics-based responses include geomechanical responses of the material.
